(19) United States
(12) Patent Application Publication
(10) Pub. No.: US 2026/0252732 A1
(43) Pub. Date: Aug. 27, 2026

(54) DIFFUSION OBFUSCATION TRANSFORM

(71) Applicant: Protopia AI, Inc., Austin, TX (US)

(72) Inventor: Kyle Mylonakis, Austin, TX (US)

(21) Appl. No.: 19/368,609

(22) Filed: Oct. 24, 2025

Related U.S. Application Data
(60) Provisional application No. 63/711,597, filed on Oct. 24, 2024.

(51) Int. Cl. G06F 21/62; G06N 20/00

(52) U.S. Cl. CPC G06F 21/6254; G06N 20/00

(57) ABSTRACT

Provided are methods and systems for obtaining, by a computer system, input data for a machine learning model; generating, by the computer system, one or more obfuscation value distribution for input data obfuscation based on a diffusion process; training, by the computer system, the one or more obfuscation value distribution for data obfuscation; and storing, by the computer system, the trained one or more obfuscation value distribution in memory.

### CROSS-REFERENCE TO RELATED APPLICATIONS

This application claims the benefit of U.S. Provisional Pat. App. 63/711,597, titled DIFFUSION OBFUSCATION TRANSFORM, filed 24 Oct. 2024, the entire content of which is hereby incorporated by reference.

### BACKGROUND

### 1. Field

This disclosure relates generally to the field of security in machine learning models and more particularly to input obfuscation for machine learning models.

### 2. Description of Related Art

Data holders (e.g., data owners, authorized data analyzers, etc.) may wish to provide their data to different types of machine learning (ML) models, including inference engines, identifiers, classifiers, foundational models, generative models, etc. Data holders, however, may be cautious of providing data, which may include sensitive information, across networks (e.g., unsecured networks) or to ML models which are owned (e.g., operated, maintained, hosted, etc.) by other entities, including data for ML training and ML inference or other operations. In order to protect information, a data holder may wish to obfuscate all or part transmitted data while preserving the ability of the ML model to be trained or operate on the obfuscated data.

### SUMMARY

The following is a non-exhaustive listing of some aspects of the present techniques. These and other aspects are described in the following disclosure.

Some aspects include application of obfuscation to input data for a machine learning model.

Some aspects include application of obfuscation to input data, where one or more obfuscation values are generated using one or more trained obfuscation distributions.

Some aspects include application of obfuscation to input data, where one or more obfuscation values are sampled randomly from one or more trained obfuscation distributions.

Some aspects include training of one or more obfuscation distribution for application of obfuscation to input data for a machine learning model.

Some aspects include generation of one or more distributions from which to select obfuscation values.

Some aspects include generation of one or more distributions from which to select one or more obfuscation values based on an optimization function.

Some aspects include generation of one or more distribution from which to select one or more obfuscation value by application of stochastic diffusion.

Some aspects include generation of one or more distribution from which to select one or more obfuscation value by application of stochastic diffusion with drift.

Some aspects include generation of one or more obfuscation values by application of stochastic diffusion.

Some aspects include generation of one or more obfuscation values by application of stochastic diffusion with drift.

Some aspects include a tangible, non-transitory, machine-readable medium storing instructions that when executed by a data processing apparatus cause the data processing apparatus to perform operations including the above-mentioned application.

Some aspects include a system, including: one or more processors; and memory storing instructions that when executed by the processors cause the processors to effectuate operations of the above-mentioned application.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an exemplary method for obfuscation value distributions based on diffusion, according to some embodiments;

FIG. 2 shows an example computing system that applies obfuscation to input data in a machine learning model, in accordance with some embodiments; and

FIG. 3 shows an example computing system that may be used in accordance with some embodiments.

FIG. 4 illustrates an exemplary obfuscation value distribution exploration using one or more diffusion processes, in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of machine learning and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Data holders—e.g., data owners, data producers, data processors, etc. —may be entities who are custodians of data, either data of their affiliated users or data they have acquired (such as through video, audio, text, or other recording or inputs)—including purchased—or generated. In some embodiments, data holders may process data by application of a model, including a machine learning model, decision tree, etc. In some embodiments, data holders may train a model, an instance of a model, part of a model, such as a data holder specific head, etc., on data they hold. In some embodiments, data holders may supply data to a trained model, which may be a model trained by the data holder, by the data holder's data, or by another entity. In some embodiments, the data may be transmitted to the model via an untrusted method, such as over a network, or by a method which may represent a data leakage risk, such as a trusted method which is susceptible to attack. In some embodiments, the data may be transmitted to a model which operates, wholly or partially, in an untrusted environment. For example, the model may be a model held entirely by an entity other than the data holder. In some embodiments, the data may be transmitted to a model which represents a data leakage risk, such as a model which processes data from other users in addition to the data of the data holder. For example, the model may be a generational model which may supply further text based on a prompt, and may operate on the input of multiple users. In some embodiments, the data holder may obfuscate data supplied to a model in order to prevent the model from incorporating, including into is architecture, training, hyperparameters, etc., the data of the data holder.

In some embodiments, the data holder may control (e.g., own, operate, etc., such as within a trusted network) the entirety or a portion of the machine learning model. For example, the data holder may be the model holder (e.g., entity which owns, operates, etc. the machine learning model, including having access to view and change parameters of the machine learning model, including hidden layers). In some embodiments, the data holder may have access to the machine learning model, but may not control the machine learning model. For example, the data holder may have exclusive or non-exclusive access to input data into a machine learning model (for example, a cloud-based model, an open-source model, a proprietary model held by a second entity) and receive output data in response, but may not have access to the model architecture, parameters, hidden layers, etc. In some embodiments, the data holder may have access to a portion (e.g., layers, architecture, etc.) of a machine learning model. For example, a machine learning model may have a known architecture, such as a known transformer block architecture or any other appropriate architecture.

At various points in data transit, such as from data acquisition apparatuses (for example, client mobile device, security camera, etc.) to the data holder (for example, via mobile applications, APIs, etc.) or from the data holder to the model (for example, via cloud-based data transfer, via cellular network, etc.), the data may be vulnerable to interception by untrusted networks, devices, entities, adversaries, etc. —even if the data holder is the model holder. In some embodiments, input to a machine learning model may be or contain sensitive data—e.g., proprietary data, protected data, trade secrets, etc. —which the data holder may have a reason (e.g., legal, ethical, contractual, commercial, etc.) to protect (for example, obfuscate). Because the data is vulnerable, e.g., when travelling outside a trusted envelope, a data holder may obfuscate the data at one or more operation to protect the privacy of the data, which may include the data holder's operation(s) upon the data (e.g., a prompt supplied with the data). The data may be in an obfuscated state when it is operated on by or transmitted over untrusted networks. In some embodiments, the data may be un-obfuscated when it is operated on by or transmitted over trusted networks.

The terms “trusted” and “untrusted” are not used in the subjective sense, and no state of mind or judgement is required. Rather the terms refer to distinct computing environments where privileges in one do not necessarily afford full access in the other. A descriptor of “untrusted” does not imply that an entity be adversarial, but rather instead includes cases where an entity may be trusted under certain conditions or to a certain extent (such as under contractual obligation of a model holder to a data holder), but who, for reasons such as conflict of interest, data-breach protection, etc., an entity treats as untrusted at least part of the time. For example, in some cases a machine learning model belonging to a model holder may be treated as trusted, such as during training which may occur on a trusted network, but may be treated as untrusted during deployment—which may occur over an untrusted network. In other embodiments, a model holder may be treated as untrusted even during training.

In some embodiments, one or more type of obfuscation may be applied to data (e.g., input data). The obfuscation may be additive—e.g., the obfuscation value may be added to the input data value. In some embodiments, the obfuscation may instead or additionally be multiplicative, divisive, subtractive, or apply obfuscation values to input data by any other appropriate mathematical operation. In some embodiments, the obfuscation may be applied to parameters, hyperparameters, etc., of a machine learning model or layer(s) of a machine learning model. In some embodiments, the obfuscation may be applied (e.g., as obfuscation values) to the input data. In some embodiments, the obfuscation may be applied, including separately, to various features of the input data (e.g., pixel values, words, sound pitch, volume, etc.). In some embodiments, the obfuscation may be applied to embeddings or other transformed values of input data. For example, numerical obfuscation values may be added to embeddings of input data from a machine learning model vocabulary to generate obfuscated embeddings or token values. In some embodiments, obfuscation may be applied to embeddings or other transformed values of input data generated, based on the input value, by one or more machine learning model such as an encoder, autoencoder, decoder, etc. For example, the obfuscation may be applied to a latent representation of input data which may be decoded to generate obfuscated input data. In some embodiments, the obfuscated input data may be generated using part of a whole machine learning model, such as a model within the trusted envelope operated by the data holder. The obfuscated input data may then be supplied to a model outside the trusted envelope, where the model outside the trusted envelope may or may not be the same as, part of (e.g., a layer of), or otherwise trained with the model within the trusted envelope. In some embodiments, the obfuscated input data may contain additional tokens or other data which is generated based on no input data or null data. For example, obfuscated input data may contain one or more tokens, pixels, sound bytes, etc. which do not correspond to un-obfuscated input data.

In some embodiments, the obfuscated input data may have a shifted mean or distribution relative to the un-obfuscated input data. In some embodiments, the obfuscated input data may preserve a mean or distribution (e.g., standard deviation) relative to the un-obfuscated input data. In some embodiments, the obfuscated input data may be generated, based on the input data, by a trained obfuscator. The obfuscator may be trained, including based on a model outside the trusted envelope, to apply different levels of obfuscation to different features of the input data, where the training may operate, such as via an optimization function, to maximize the amount of obfuscation applied to the input data while preserving operation of the model on the obfuscated input data relative to the un-obfuscated input data. Any appropriate optimization method may be used, including gradient descent, stochastic gradient descent, etc. In some embodiments, the obfuscator may be trained to select obfuscation values, including separately for each feature, value, pixel, etc. of input data, from an obfuscation distribution. In some embodiments, the obfuscation values may be randomly sampled from the obfuscation distributions. In some embodiments, the obfuscation values may be sampled, such as during deployment, by using any appropriate numerical solver, including in one, two, or more iterations (e.g., 5, 10, 20, 100, 1000, etc. iterations), applied to any appropriate diffusion process. In some embodiments, the features of the input data which influence the outcome of the model may be determined based on the distribution of the obfuscation value distribution for the feature. For example, features which are less important to inference may have larger distributions for obfuscation values than features which are more important to inference. As used herein, obfuscation may also be referred to as “noise”, although obfuscation and obfuscation values (and grammatical conjugates thereof) are not required to be random, but may be random, quasi-random, determinate, etc.

In some embodiments, the machine learning model(s) may be an ensemble of machine learning models. In some embodiments, the machine learning model may be a large language model (LLM). In some embodiments, the machine learning model may be a LLaMa model. In some embodiments, the machine learning model may be a foundational model. In some embodiments, the machine learning model may be a generative model. In some embodiments, the machine learning model may be a classifier. The machine learning model may be any appropriate model, which takes any appropriate form of input, including text, visual, audio, video, etc. In some embodiments, the machine learning model may have some open-source components, such as information about architecture. In some embodiments, the machine learning model may be a non-open-source model, such as a proprietary model, licensed model, etc., which the model-user may have permission to use. In some embodiments, the machine learning model may be held by the data holder (e.g., the data holder may be the model holder. In some embodiments, the machine learning model may be a generative model, including a generative language model. In some embodiments, the machine learning model may accept multiple inputs, which may include prompts.

In some embodiments, input to the machine learning model may be obfuscated in one or more ways. Training data may be obfuscated. Deployed data may be obfuscated. Inference data may be obfuscated. Input data may be obfuscated by any appropriate manner. Data may be obfuscated in one or more way, including by addition of obfuscation to input data in determined in multiple manners, applied at multiple times, applied in multiple manners, etc., such as by methods including obfuscations trained by self-supervision as are described in U.S. patent application Ser. No. 18/303,454, titled SELF-SUPERVISED DATA OBFUSCATION IN FOUNDATION MODELS, filed 19 Apr. 2023, (describing obfuscation operations and data obfuscation in reference to foundation models, including language models), by conditional noise (e.g., obfuscation) layers as are described in U.S. patent application Ser. No. 18/114,165, titled CONDITIONAL NOISE LAYERS FOR GENERATING ADVERSARIAL EXAMPLES, filed 24 Feb. 2023 (describing conditional noise layers), by obfuscations trained by limited supervision as are described in U.S. patent application Ser. No. 18/170,476, titled OBFUSCATION OF ENCODED DATA WITH LIMITED SUPERVISION, filed 16 Feb. 2023 (describing obfuscation of embeddings of input data), by generation of quasi-synthetic data as are described in U.S. Provisional Patent Application 63/311,014, titled QUASI-SYNTHETIC DATA GENERATION FOR MACHINE LEARNING MODELS, filed 16 Feb. 2022 (describing generation of quasi-synthetic input data suitable for use with machine learning models based on un-obfuscated input data), by obfuscations trained by self-supervision as are described in U.S. Provisional Patent Application 63/420,287, titled SELF-SUPERVISED DATA OBFUSCATION, filed 28 Oct. 2022 (describing data obfuscation operations) and U.S. patent application Ser. No. 18/303,454, titled SELF-SUPERVISED DATA OBFUSCATION IN FOUNDATIONAL MODELS, filed 19 Apr. 2023, by obfuscations trained to obfuscate output as are described in U.S. Provisional Patent Application 63/594,944, titled OUTPUT OBFUSCATION FOR MACHINE LEARNING MODELS, filed 31 Oct. 2023 (describing output obfuscation methods and tuned client model heads), and by transformer block based obfuscation as are described in U.S. Provisional Patent Application 63/603,061, titled TRANSFORMER BLOCK BASED OBFUSCATION, filed 27 Nov. 2023, the entire content of each of which is hereby incorporated by reference. Examples of noise distributions and stochastic gradient methods that may be used for data obfuscations, including input data obfuscations, distribution obfuscation, etc., are described in U.S. Provisional Patent Application 63/227,846, titled STOCHASTIC LAYERS, filed 30 Jul. 2021, and U.S. patent application Ser. No. 17/680,108, titled STOCHASTIC NOISE LAYERS, filed 24 Feb. 2022 (describing examples of stochastic layers with for data obfuscation); U.S. Provisional Patent Application 63/221,738, titled REMOTELY-MANAGED, NEAR-STORAGE OR NEAR-MEMORY DATA TRANSFORMATIONS, filed 14 Jul. 2021, and U.S. patent application Ser. No. 17/865,273, titled REMOTELY-MANAGED, DATA-SIDE DATA TRANSFORMATION, filed 14 Jul. 2024 (describing data transformations that may be used with the present techniques, e.g., on input data); and U.S. Provisional Patent Application 63/153,284, titled METHODS AND SYSTEMS FOR SPECIALIZING DATASETS FOR TRAINING/VALIDATION OF MACHINE LEARNING, filed 24 Feb. 2021 (describing examples of obfuscation techniques that may be used with the present techniques); each of which is hereby incorporated by reference. In some embodiments, input data may be obfuscated in a way that leaves the obfuscated data suitable for training a machine learning model or performing inference but conceals the un-obfuscated version of the training data. To train the obfuscator, some embodiments obtain training data, train a transformer on the training data, and may learn parameters of parametric noise distributions for inserted noise layers (e.g., applied by one or more estimators). The noise distributions may be learned with the techniques described in U.S. patent application Ser. No. 17/458,165, filed 26 Aug. 2021, titled METHODS OF PROVIDING DATA PRIVACY FOR NEURAL NETWORK BASED INFERENCE, the contents of which are hereby incorporated by reference.

In some embodiments, obfuscation value distributions are determined, with or without reference to a machine learning model. In some embodiments, obfuscation value distributions are determined with reference to an autoencoder or other machine learning model which encodes and decodes input data. In some embodiments, obfuscation value distributions are determined with reference to a trained or untrained (including a machine learning model co-trained with the obfuscation value distributions) machine learning model or part (e.g., layers) thereof.

In some embodiments, obfuscation value distributions are determined based on a stochastic diffusion process, such as a stochastic diffusion process. In some embodiments, a diffusion process, such as a stochastic diffusion process, is determined based on one or more diffusion equations, such as a stochastic diffusion equation. In some embodiments, a diffusion process is determined based on one or more iterations (e.g., jumps, directional changes, parameterized values, etc.) of behavior occurring as described by a diffusion equation. The diffusion process may be an autonomous (e.g., time-independent) diffusion process. In some embodiments, obfuscation values are determined based on a stochastic diffusion process, with or without direct determination of an obfuscation value distribution. Diffusion, being a physical or random process, is unrelated to obfuscation values on the face. However, results indicate that diffusion processes may be used to model (e.g., map) multi-dimensional obfuscation value manifolds, including when combined with optimization functions.

In some embodiments, obfuscation value distributions are determined based on a stochastic diffusion process with drift. In some embodiments, obfuscation values are determined based on a stochastic diffusion process with drift, with or without direct determination of an obfuscation value distribution.

In some embodiments, the stochastic diffusion process is modeled by Ito diffusion (e.g., Ito diffusion equation, Markov process, etc.). In some embodiments, the stochastic diffusion process is modeled by any appropriate diffusion process, described (e.g., bound) by any appropriate diffusion equation, include any appropriate stochastic differential equation (SDE). The diffusion process may be a numerical approximation of a stochastic diffusion process. The diffusion process may be generated by using a numerical approximation of a differential equation (e.g., an SDE). Any appropriate numerical approximation or numerical solver may be used, some of which are described later. In some embodiments, diffusion may dominate (e.g. be a larger, much larger, etc. contributor to than) drift. In some embodiments, drift may dominate (e.g. be a larger, much larger, etc. contributor to than) diffusion. In some embodiments, obfuscation value distributions are modeled by multiple calculations of diffusion processes (with or without drift) for multiple particles, which behaviors (e.g., paths) may be concatenated, averaged (including weighted-averaged), or otherwise joined. In some embodiments, obfuscation value distributions may be determined based on bulk properties, e.g., diffusion (with or without drift) for a set of multiple particles, for which an expectation value may or may not be determined. In some embodiments, expectation values for diffusion processes of more than one step may be dependent on both drift and diffusion coefficients. In some embodiments, the obfuscation value distribution may consist of multiple overlapping, non-overlapping, contiguous, disparate, etc. distributions. In some embodiments, obfuscation value distributions may be different depending on the number of step iterations used to determine the diffusion process. In some embodiments, the obfuscation value distribution may be contiguous in some projections, but not others. In some embodiments, the obfuscation value distribution may be higher dimensional, including having more or many more dimensions (such as greater by a factor of 2, 5, 10, 100, 1000, etc.) than the input data, features of the input data, embeddings or the input data, etc., or lower dimensional, including having fewer dimensions (such as greater by a factor of 2, 5, 10, 100, 1000, etc.) than the input data, features of the input data, embeddings or the input data, etc. The space occupied by the obfuscation value distribution may be a manifold.

In some embodiments, the obfuscation value distributions, or manifold, may require special computing, including specially designed, architected, powered, etc., computing devices in order to determine. In some embodiments, the obfuscation value distributions may require multiple iterations, including 1, 10, 100, 1,000, iterations, to be determined, including to a certain level of convergence. In some embodiments, convergence may not be a requirement or even checked for. In some embodiments, obfuscation values may be determined as data is obfuscated, including by sampling from obfuscation value distributions or by direct calculation or numerical approximation, etc. In some embodiments, the obfuscation values may be applied to the input data by any appropriate transform, hereinafter referred to as an “obfuscation transform,” which may be an application of the diffusion process.

Reference to “minimums” and “maximums” and “optimizations” should not be read as limited to finding these values with absolute precision and includes approximating these values within ranges that are suitable for the use case and adopted by practitioners in the field. It is generally not feasible to compute “minimums” or “maximums” or “optimizations” to an infinite number of significant digits and spurious claim construction arguments to this effect should be rejected.

Variants of the Stained Glass Transform may work by learning an optimal Gaussian distribution which additively perturbs the original data. Technologies such as transformer cloak and patch cloak may allow for more accurate estimates of the means vector and variance matrix of this Gaussian to be learned, but the transformation may fundamentally be an additive Gaussian. The manifold (which may or may not include the boundary) of transformed data which is compatible with the downstream task (be it an LLM, classification model, or any other kind of differentiable machine learning model) may be unlikely to be globally well approximated by such a Gaussian distribution. As such, the learned transformed representations may be significantly limited by demanding the transformed distribution be a Gaussian.

The result of this is that stained glass transformations may suffer in that they may only ever manifest as a small portion of the actual allowable transformations. In particular, transformed samples may only ever look like perturbations around some point which itself may not be significantly transformed. For some of models, this may produce very low shifted perturbation scores (which low shift itself may function as an oracle attack against the model, especially is an attacker knows the original data and that the perturbations were generated by a Gaussian).

Instead of the above, the mapping of data to Gaussian distributions may be generalized to mappings of data to probability distributions of Itô diffusion processes at some time T. The class of distributions may be a strict generalization of Gaussian processes, but may generate an infinite dimensional function space as compared to the finite dimensional function space of Gaussian distributions. Diffusion processes may be modeled by stochastic differential equations (SDEs) and the numeric approximation of SDEs may allow one to compute the samples of these distributions in a straightforward manner. Using diffusion processes as the transformation may allow for a much richer and globally defined set of transformations to be learnable as compared to Gaussian methods

### Cloak Transform

The cloak transform may be described by the following: Let X⊆ [symbol] be a dataset. Let μ∈ [symbol] and let Σ∈M_{d}( [symbol] ) be a positive semidefinite matrix. Let [symbol] (μ, Σ): [symbol] → [symbol] be a d-dimensional multivariate Gaussian distribution and let N_{μ,Σ}:Ω→ [symbol] be a random variable defined on the probability space (Ω, [symbol] , [symbol] ) with distribution [symbol] (μ, Σ). Let L²(Ω, [symbol] ) be the set of [symbol] valued finite variance random variables on Ω. Further, let D_{d}( [symbol] ) be the set of d-dimensional diagonal matrices with coefficients in [symbol] and let D_{d}⁺( [symbol] )⊆D_{d}( [symbol] ) be the subset of positive semidefinite matrices.

Let μ: [symbol] → [symbol] and Σ:

$${ℝ}^{d} \to {D}_{d}^{+} ( ℝ )$$

be piecewise differentiable functions on [symbol] . Then the cloak transform T: [symbol] →L²(Ω, [symbol] ) may then be defined by T(x)=x+ [symbol] _{(x), Σ(x)}.

### Itô Diffusion Stained Glass Transform

An Itô processes may also known as diffusion processes, and may be described in full by Diffusion, Markov Processes and Martingales: Volume 2, Itô Calculus, which is hereby incorporated by reference. For ease of description, certain terms (e.g., of the Itô process) are described following. A (finite-variance) stochastic process is a function X: [symbol] →L²(Ω, [symbol] ). One may write X(t)=Xₜ, such as to emphasize that the variable t, often thought of as time, is parameterizing a family of random variables. A particularly important stochastic process is known as the Wiener process Wₜ which has the following properties which (e.g., uniquely) characterize it: (1)Wₜ=0 substantially always; (2) If 0≤t₁<t₂< . . . <tₖ, then Wₜ_{₁}, Wₜ_{₂}−Wₜ_{₁}, . . . , Wₜ_{ₖ}−Wₜ_{ₖ₋₁} are all mutually independent; (3) For all 0≤t and h>0, Wₜ₊ₕ−Wₜ is Gaussian with mean 0 and covariance hI, where I is the identity matrix; and (4) For almost all fixed ω∈Ω, the function (path) [symbol] (ω): [symbol] → [symbol] W defined by [symbol] (ω)(t)=Wₜ(ω) is continuous for all g≥0. The Wiener process may be used to model Brownian motion, and it may be used to define stochastic integration.

An Itô diffusion process, hereinafter also referred to as a diffusion process, may be described as the solution to the following stochastic differential equation (SDE): dXₜ=μ(Xₜ,t)dt+Σ(Xₜ,t)dWₜ. Much like ordinary differential equations, stochastic differential equations may require initial conditions in order for solutions of them to exist (e.g., to be solvable). The functions μ and Σ may be through of as the drift and diffusion coefficients respectively (even for non-physically applications of the diffusion equations). They may be written with time dependence, and so are non-autonomous. For the purposes of simplicity, the Itô diffusion Stained Glass Transform may be described as having autonomous drift and diffusion coefficients so that it satisfies the SDE dXₜ=μ(Xₜ)dt+Σ(Xₜ)dWₜ

To characterize an Itô transform, fix xΣ [symbol] and let

$${X}_{t}^{x}$$

be a solution to the SDE of equation above with initial condition

$${X}_{0}^{x} = x ∈ {ℝ}^{d} .$$

fix some time t>0. Then, the Itô diffusion Stained Glass Transform at time t is defined as the transformation Tₜ: [symbol] →L²(Ω, [symbol] ) where

$${T}_{t} ( x ) = {X}_{t}^{x} .$$

While an SDE may be used to define an Itô process, but, in general, analytic solutions to dXₜ=μ(Xₜ)dt+Σ(Xₜ)dWₜ may not be findable in all but the most simple cases. Instead, much like their deterministic cousins, numerics may be needed in order to find solutions to SDEs. The simplest numerical scheme for SDE solution may be the Euler-Maruyama method, which may be described as the stochastic analog of forward Euler. Much like forward Euler, it may have low orders of convergence and numerical stability issues, and so may be less useful in practical applications. Since only the drift and diffusion coefficients of the SDE are accessible in some embodiments, schemes which use derivative information, such as Milstein may also not be practical. As a result, stochastic Runge-Kutta schemes may be the best avenues for SDE solution in some embodiments. The advantage of these methods may be the same as their deterministic cousins: they may exhibit higher order convergence and may be more numerically stable. A disadvantage is that they may be more expensive to compute. In applications where one is not simulating dynamics to make predictions, the low order of convergence may not be an issue (e.g., in BF-16 after all). The numerical stability on the other hand may or may not be an issue for these solutions, but different methods may be ideal for different solutions.

Example solutions are described as follows. In a first example, fix N>0 and suppose that we have a uniform time grid 0=t₀<t₁< . . . <t_{N}=1 where each

$${t}_{i} = \frac{i}{N} .$$

Fix x∈ [symbol] and suppose that X₀=x. Then the Euler-Maruyama approximation/discretization of the autonomous Itô diffusion given by dXₜ=μ(Xₜ)dt+Σ(Xₜ)dWₜ at tᵢ is defined by

$${X}_{{t}_{n + 1}} = {X}_{{t}_{n}} + \frac{n}{N} μ ( {X}_{{t}_{n}} ) + Δ {W}_{{t}_{n}} \sum ( {X}_{{t}_{n}} )$$

where each ΔWₜ_{ₙ} are independent and identically distributed (i.i.d.) Gaussian random variables with mean 0 and variance

$$\frac{1}{N} .$$

In a second example, fix N>0 and suppose that we have a uniform time grid 0=t₀<t₁< . . . <t_{N}=1 where each

$${t}_{i} = \frac{i}{N} .$$

Fix x∈ [symbol] and suppose that X₀=x. Then let

$${χ}_{{t}_{n}} = {X}_{{t}_{n}} + μ ( {X}_{{t}_{n}} ) \frac{1}{N} + \sqrt{\frac{1}{N}} \sum ( {X}_{{t}_{n}} ) .$$

Then the strong order 1 Runge-Kutta scheme is defined as

$${χ}_{{t}_{n + 1}} = {X}_{{t}_{n}} + μ ( {X}_{{t}_{n}} ) \frac{1}{N} + Δ {W}_{{t}_{n}} \sum ( {X}_{{t}_{n}} ) + \frac{1}{2} ( \sum ( {χ}_{{t}_{n}} ) - \sum ( {X}_{{t}_{n}} ) ) ( {( Δ {W}_{{t}_{n}} )}^{2} - \frac{1}{N} ) {( \frac{1}{N} )}^{- \frac{1}{2}}$$

where each ΔWₜ_{ₙ} are i.i.d. Gaussian random variables with mean 0 and variance

$$\frac{1}{N} .$$

In some embodiments, amongst all the properties of Itô processes, a few may stand as particularly advantages for data obfuscation, such as the Itô version of the chain rule, and the backward and forward Kolmogorov equations

### Itô's Lemma

Suppose that Xₜ=a(t)dt+b(t)dWₜ is an Itô process on [symbol] and let ƒ: [symbol] × [symbol] → [symbol] then the composite function ƒ(Xₜ, t) satisfies the stochastic differential equation

$$df = \frac{\partial f}{\partial t} dt + {∇}_{x} {f}^{T} {dX}_{t} + \frac{1}{2} {dX}_{t}^{T} {H}_{x} {fdX}_{t} [ \frac{\partial f}{\partial t} + {∇}_{x} {f}^{T} a ( t ) + \frac{1}{2} Tr [ {b}^{T} ( {H}_{x} f ) b ] dt + \frac{1}{2} {∇}_{x} {f}^{T} {dW}_{t}$$

The Itô process shows that the chain rule for diffusion processes may behave slightly differently, with the drift term of the composite function affected by the diffusion term of the underlying process Xₜ.

### Generators

Generators of diffusion may allow the sample trajectories of the SDE to be connected to evolution of their probability distributions.

For an Itô diffusion, the generator A of the autonomous Itô diffusion given by dXₜ=μ(Xₜ)dt+Σ(Xₜ)dWₜ with initial conditions given by X₀=0 may be described using

$$( A f ) ( x ) = {lim}_{t ↓ 0} \frac{𝔼 [ f ( {X}_{t} ) - f ( x ) ]}{t}$$

In the above, and subsequent sections, all expectations are evaluated over the “space” variable “x”. When ƒ is a twice continuously differentiable function with compact support in x then the generator reduces to

$$( A f ) ( x ) = μ ( x ) \cdot {∇}_{x} f + \frac{1}{2} {\sum }_{i , j} {( \sum {\sum }^{T} )}_{i , j} ( x ) \frac{{\partial }^{2} f}{\partial {x}_{i} \partial {x}_{j}}$$

The name generator may arise from the Dynkin formula which gives

$$𝔼 [ f ( {X}_{t} ) ] = f ( x ) + 𝔼 [ {\int }_{0}^{t} ( A f ) ( {X}_{s} ) d s$$

### Backwards Kolmogorov Equation

It may then be possible to differentiate [symbol] [ƒ(Xₜ)] with respect to t, which may give

$${\partial }_{t} 𝔼 [ f ( {X}_{t} ) ] = 𝔼 [ ( Af ) ( {X}_{t} ) ]$$

If [symbol] [ƒ(Xₜ)] is described by u(x,t)= [symbol] [ƒ(Xₜ)](where X₀=x as previously described), then this may be reduced to

$${\partial }_{t} u = Au , u > 0$$

$$u ( 0 , x ) = f ( x )$$

### Forward Kolmogorov Equation (Fokker-Plank)

The adjoint operator of A, A*n may be shown to satisfy the functional ordinary differential equation (ODE)

$$\frac{d}{d t} {p}_{t} ( x , y ) = A * {p}_{t} ( x , y )$$

For all x,y ∈ [symbol] where pₜ(x,y) is the transition probability density at time t. The adoint of an operator A may be described as the A* that satisfies [symbol] Aƒ,g [symbol] = [symbol] ƒ,A*g [symbol] for substantially sufficiently smooth supported functions ƒ and g.

In some embodiments, the Feynman-Kac equation may also be used.

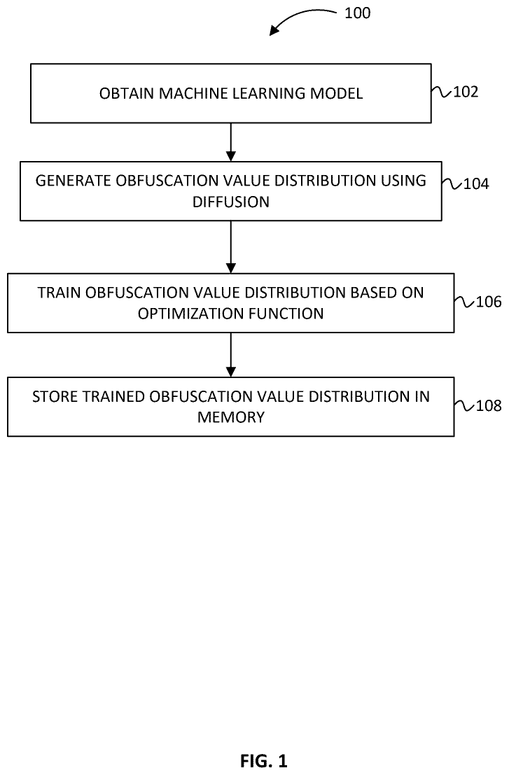

FIG. 1 illustrates an exemplary method 100 for training obfuscation values for input data. Each of these operations is described in detail below. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 1 and described below is not intended to be limiting. In some embodiments, one or more portions of method 100 may be implemented (e.g., by simulation, modeling, etc.) in one or more processing devices (e.g., one or more processors). The one or more processing devices may include one or more devices executing some or all of the operations of method 100 in response to instructions stored electronically on an electronic storage medium. The one or more processing devices may include one or more devices configured through hardware, firmware, and/or software to be specifically designed for execution of one or more of the operations of method 100, for example. For illustrative purposes, optional operations are depicted with dashed lines. However, operations which are shown with unbroken lines may also be optional or may be omitted.

At an operation 102, a machine learning model is obtained. The machine learning model may be any appropriate machine learning model including transformer architecture. The machine learning model may be an LLM, an image model, a voice recognition model, etc. The machine learning model may operate on sequential input data, including embeddings, tokens, etc. The machine learning model may be a foundational model. The machine learning model may be a generative model. The machine learning model may be obtained in full or in part. The machine learning model may be obtained as a transformer block. The machine learning model may be obtained as a truncated model.

At an operation 104, one or more obfuscation value distribution is obtained using a diffusion process. The diffusion process may be one which satisfies any appropriate diffusion equation, which may be a stochastic diffusion equation. The diffusion process may or may not include drift. The diffusion process may contain one or more variables which may fit a strength of diffusion or drift, or a combination thereof (such as a diffusion and drift coefficient, a second order diffusion coefficient, a second order drift coefficient, etc.). The coefficients may be any appropriate coefficients, such as those previously described. The diffusion process may be a stochastic diffusion process. The diffusion equation, such as may be used to model the diffusion process, may be a stochastic differential equation. The obfuscation value distribution may be determined based on the diffusion process by any appropriate method, including by the use of any appropriate estimator. The obfuscation value distribution may be any appropriate distribution, such as those previously described.

At an operation 106, the obfuscation value distribution may be trained (including retrained, additionally trained, etc.) based on the obtained machine learning model and input data. The obfuscation value distribution may be trained by adjustment of one or more coefficient, such as a diffusion coefficient, a drift coefficient, etc., to fit the diffusion process or a description (mathematical or otherwise) of the diffusion processes, to a manifold of obfuscation values. In some embodiments, the obfuscation value distribution may be trained concurrently with the generation of the obfuscation value distribution as described in the operation 104. The input data may be a set of training data, e.g., supervised training data, which includes input data and output of the machine learning model for the input data. The input data may be a set of training data, e.g., unsupervised data, which includes input data but no output of the machine learning model for the input data. In some embodiments, the training data may be used, together with the obtained machine learning model in truncated or untruncated form, to train the obfuscation value distributions in a self-supervised or semi-supervised manner. In some embodiments, reinforcement learning, including reinforcement learning from human feedback, may be used. In some embodiments, the obfuscation value distributions may be trained based on an optimization function which may maximize noise (in the obfuscated input data with respect to the un-obfuscated input data) and minimize loss (in the output of the machine learning model based on the obfuscated input data with respect to the output of the machine learning model based on the un-obfuscated input data). In some embodiments, a teacher-student distillation technique may be used. The obfuscation value distributions may be trained independently or co-trained. The training may conclude when any appropriate termination criterion is reached.

At an operation 108, parameters of the trained obfuscation value distributions may be stored in memory. The parameters may be coefficients of one or more description of a diffusion process. The parameters may be equations, with or without fitted parameters, which may be used, including iterative, to generate (e.g., describe) a diffusion path (e.g., for a particle) or a diffusion process. The trained obfuscation value distributions may be deployed, such as NNs, on a trusted network to obfuscate data for transmission by untrusted means. The trained obfuscation value distributions may be applied on a client-side data store, such as on a user device, a client data store, a trusted cloud, etc. The trained obfuscation value distributions may operate on input data at inference. The trained obfuscation value distributions may output a sequential obfuscation which may be applied to the input data at inference. The trained obfuscation value distributions may include one or more parameters to adjust, including in real time, a tradeoff between obfuscation and loss (e.g., performance of the machine learning model on obfuscated data). For example, the trained obfuscation distributions may be turned up or down based on deployment obfuscation needs, such as by increasing obfuscation to protect some data with a corresponding loss in model accuracy or by decreasing obfuscation on some data in order to increase model accuracy.

As described above, method 100 (and/or the other methods and systems described herein) is configured to provide a generic framework for input obfuscation based on a transformer block.

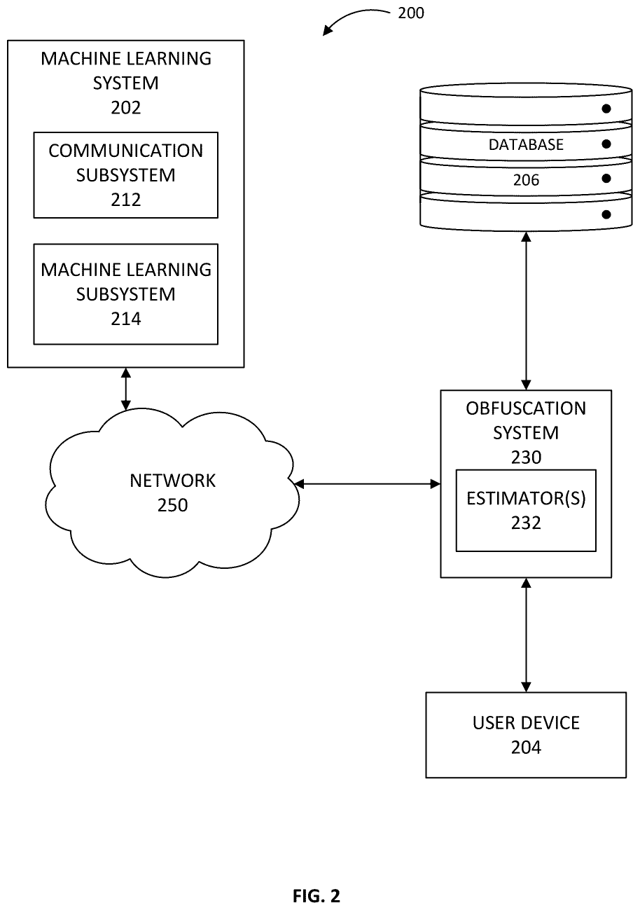

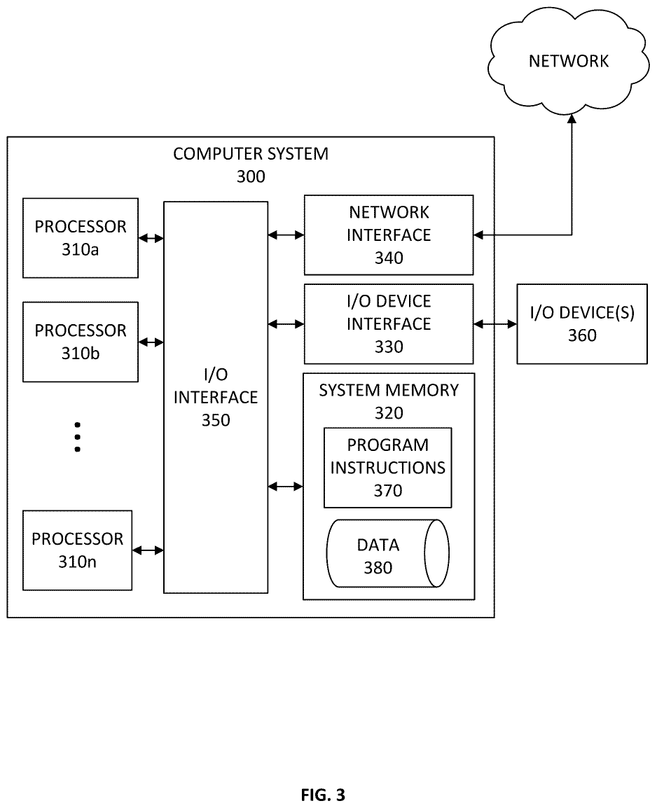

FIG. 2 shows an example computing system 200 for implementing data obfuscation in machine learning models. The computing system 200 may include a machine learning (ML) system 202, an obfuscation system 230, a user device 204, and a database 206. The ML system 202 may include a communication subsystem 212, and a machine learning (ML) subsystem 214. The communication subsystem 212 may retrieve one or more datasets from the database 206 for use in training or performing inference via the ML subsystem 214 (e.g., using one or more machine-learning models described in connection with FIG. 3). The obfuscation system 230 may include one or more estimators 232. The estimators 232 may apply obfuscation to data transmitted to the ML system 202, such as from the input device 204 or the database 206. The obfuscation system 230 is depicted between the input device 204 and the database 206 and the network 250, but may be at any appropriate location, such as on a trusted network containing the input device 204 and the database 206.

One or more machine learning models used (e.g., for training or inference) by the ML subsystem 214 may include one or more transformers blocks. The ML subsystem 214 may be a foundation model, an LLM, a generative model, etc. The one or more obfuscated values (e.g., obfuscated output, encrypted output, encoded output, etc.) generated by the obfuscation system 230 may be used as input the ML system 202.

The estimators 232 may be trained via gradient descent (e.g., stochastic gradient descent) and backpropagation, or a variety of other training methods. One or more parameters may be trained, for example, because the one or more parameters are differentiable with respect to one or more other parameters of the machine learning model.

The user device 204 may be a variety of different types of computing devices, including, but not limited to (which is not to suggest that other lists are limiting), a laptop computer, a tablet computer, a hand-held computer, smartphone, other computer equipment (e.g., a server or virtual server), including “smart,” wireless, wearable, Internet of Things device, or mobile devices. The user device 204 may be any device used by a healthcare professional (e.g., a mobile phone, a desktop computer used by healthcare professionals at a medical facility, etc.). The user device 204 may send commands or data to the obfuscation system 230. In some embodiments, the user device 204 may send commands or data to the ML system 202. Although only one user device 204 is shown, the system 200 may include any number of client devices.

The ML system 202 may include one or more computing devices described above and may include any type of mobile terminal, fixed terminal, or other device. For example, the ML system 202 may be implemented as a cloud computing system and may feature one or more component devices. Users may, for example, utilize one or more other devices to interact with devices, one or more servers, or other components of system 200. In some embodiments, operations described herein as being performed by particular components of the system 200, may be performed by other components of the system 200 (which is not to suggest that other features are not also amenable to variation). As an example, while one or more operations are described herein as being performed by components of the ML system 202, those operations may be performed by components of the user device 204 or database 206 or the obfuscation system 230. In some embodiments, the various computers and systems described herein may include one or more computing devices that are programmed to perform the described functions. In some embodiments, multiple users may interact with system 200. For example, a first user and a second user may interact with the ML system 202 and the obfuscation system 230 using two different user devices.

One or more components of the ML system 202, obfuscation system 230, user device 204, and database 206, may receive content and other data via input/output (hereinafter “I/O”) paths. The one or more components of the ML system 202, obfuscation system 230, the user device 204, and/or the database 206 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the ML system 202, obfuscation system 230, the user device 204, and the database 206 may have neither user input interface nor displays and may instead receive and display content using another device (e.g., a dedicated display device such as a computer screen and/or a dedicated input device such as a remote control, mouse, voice input, etc.). Additionally, the devices in system 200 may run an application (or another suitable program). The application may cause the processors and other control circuitry to perform operations related to weighting training data (e.g., to increase the efficiency of training and performance of one or more machine-learning models described herein).

One or more components or devices in the system 200 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically, magnetically, or optically readable storage media. The electronic storages may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 2 also includes a network 250. The network 250 may be the Internet, a mobile phone network, a mobile voice or data network (e.g., a 5G or LTE network), a cable network, a public switched telephone network, a combination of these networks, or other types of communications networks or combinations of communications networks. The devices in FIG. 2 (e.g., the ML system 202, the obfuscation system 230, the user device 204, and/or the database 206) may communicate (e.g., with each other or other computing systems not shown in FIG. 2) via the network 250 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 2 may include additional communication paths linking hardware, software, and/or firmware components operating together. For example, the ML system 202, any component of the ML system 202 (e.g., the communication subsystem 212 or the large ML subsystem 214), the obfuscation system 230 and any estimator 232 of the obfuscation system 230, the user device 204, and/or the database 206 may be implemented by one or more computing platforms.

In some embodiments, the machine-learning models may include a Bayesian network, such as a dynamic Bayesian network trained with Baum-Welch or the Viterbi algorithm. Other models may also be used to account for the acquisition of information over time to predict future events, e.g., various recurrent neural networks, like long-short-term memory models trained on gradient descent after loop unrolling, reinforcement learning models, and time-series transformer architectures with multi-headed attention. In some embodiments, some or all of the weights or coefficients of models described herein may be calculated by executing a machine learning algorithm on a training set of historical data. Some embodiments may execute a gradient descent optimization to determine model parameter values. Some embodiments may construct the model by, for example, assigning randomly selected weights; calculating an error amount with which the model describes the historical data and a rate of change in that error as a function of the weights in the model in the vicinity of the current weight (e.g., a derivative, or local slope); and incrementing the weights in a downward (or error reducing) direction. In some cases, these steps may be iteratively repeated until a change in error between iterations is less than a threshold amount, indicating at least a local minimum, if not a global minimum. To mitigate the risk of local minima, some embodiments may repeat the gradient descent optimization with multiple initial random values to confirm that iterations converge on a likely global minimum error. Other embodiments may iteratively adjust other machine learning models to reduce the error function, e.g., with a greedy algorithm that optimizes for the current iteration. The resulting, trained model, e.g., a vector of weights or thresholds, may be stored in memory and later retrieved for application to new calculations on newly calculated aggregate estimates.

In some cases, the amount of training data may be relatively sparse. This may make certain models less suitable than others. In such cases, some embodiments may use a triplet loss network or Siamese networks to compute similarity between out-of-sample records and example records in a training set, e.g., determining based on cosine distance, Manhattan distance, or Euclidian distance of corresponding vectors in an encoding space (e.g., with more than 5 dimensions, such as more than 50).

Run time may process inputs outside of a training set and may be different from training time, except for in use cases like active learning. Random selection includes pseudorandom selections. In some cases, the neural network may be relatively large, and the portion that is non-deterministic may be a relatively small portion. The neural network may have more than 10, 50, or 500 layers, and the number of stochastic layers may be less than 10, 5, or 3, in some cases. In some cases, the number of parameters of the neural network may be greater than 10,000; 100,000; 1,000,000; 10,000,000; 10,000,000,000, or even more; while the number of stochastic parameters may be less than 10%, 5%, 1%, or 0.1% of that. This is expected to address problems that arise when traditional probabilistic neural networks attempt to scale, which with many approaches, produces undesirably excessive scaling in memory or run time complexity. Other benefits expected of some embodiments include enhanced interpretability of trained neural networks based on statistical parameters of trained stochastic layers, the values of which may provide insight (e.g., through visualization, like by color coding layers or components thereof according to values of statistical parameters after training) into the contribution of various features in outputs of the neural network, enhanced privacy from injecting noise with granularity into select features or layers of the neural network making downstream layers our outputs less likely to leak information, and highlighting layers or portions thereof for pruning to compress neural networks without excessively impairing performance by removing those components that the statistical parameters indicate are not contributing sufficiently to performance. In some cases, the stochastic layers may be partially or fully constituted of differential parameters adjusted during training, which is expected to afford substantial benefits in terms of computational complexity during training relative to models with non-differentiable parameters. That said, embodiments are not limited to systems affording all of these benefits, which is not to suggest that any other description is limiting.

FIG. 3 is a diagram that illustrates an exemplary computing system 300 in accordance with embodiments of the present technique. Various portions of systems and methods described herein may include or be executed on one or more computer systems similar to computing system 300. Further, processes and modules described herein may be executed by one or more processing systems similar to that of computing system 300.

Computing system 300 may include one or more processors (e.g., processors 310a-310n) coupled to system memory 320, an input/output (I/O) device interface 330, and a network interface 340 via an input/output (I/O) interface 350. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 300. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 320). Computing system 300 may be a units-processor system including one processor (e.g., processor 310a), or a multi-processor system including any number of suitable processors (e.g., 310a-310n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 300 may include a plurality of computing devices (e.g., distributed computer systems) to implement various processing functions.

I/O device interface 330 may provide an interface for connection of one or more I/O devices 360 to computing system 300. I/O devices may include devices that receive input (e.g., from a user) or output information (e.g., to a user). I/O devices 360 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 360 may be connected to computing system 300 through a wired or wireless connection. I/O devices 360 may be connected to computing system 300 from a remote location. I/O devices 360 located on remote computer system, for example, may be connected to computing system 300 via a network and network interface 340.

Network interface 340 may include a network adapter that provides for connection of computing system 300 to a network. Network interface 340 may facilitate data exchange between computing system 300 and other devices connected to the network. Network interface 340 may support wired or wireless communication. The network may include an electronic communication network, such as the Internet, a local area network (LAN), a wide area network (WAN), a cellular communications network, or the like.

System memory 320 may be configured to store program instructions 370 or data 380. Program instructions 370 may be executable by a processor (e.g., one or more of processors 310a-310n) to implement one or more embodiments of the present techniques. Program instructions 370 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 320 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 320 may include a non-transitory computer readable storage medium that may have program instructions stored thereon that are executable by a computer processor (e.g., one or more of processors 310a-310n) to cause the subject matter and the functional operations described herein. A memory (e.g., system memory 320) may include a single memory device and/or a plurality of memory devices (e.g., distributed memory devices).

I/O interface 350 may be configured to coordinate I/O traffic between processors 310a-310n, system memory 320, network interface 340, I/O devices 360, and/or other peripheral devices. I/O interface 350 may perform protocol, timing, or other data transformations to convert data signals from one component (e.g., system memory 320) into a format suitable for use by another component (e.g., processors 310a-310n). I/O interface 350 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 300 or multiple computer systems 300 configured to host different portions or instances of embodiments. Multiple computer systems 300 may provide for parallel or sequential processing/execution of one or more portions of the techniques described herein.

Those skilled in the art will appreciate that computing system 300 is merely illustrative and is not intended to limit the scope of the techniques described herein. Computing system 300 may include any combination of devices or software that may perform or otherwise provide for the performance of the techniques described herein. For example, computing system 300 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 300 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 300 may be transmitted to computing system 300 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

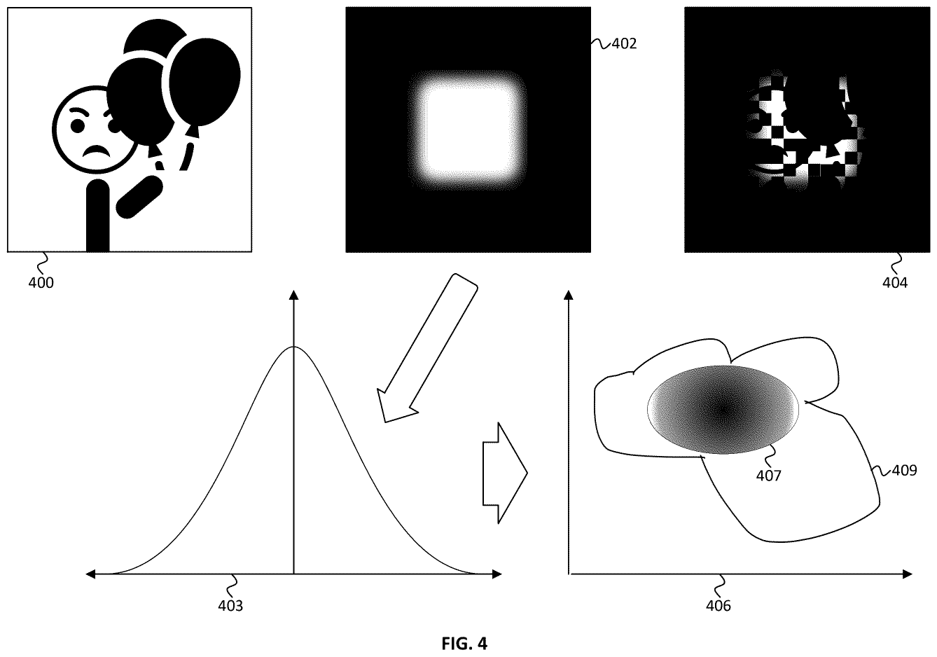

FIG. 4 illustrates an exemplary obfuscation value distribution exploration using one or more diffusion processes, in accordance with some embodiments. FIG. 4 depicts an example un-obfuscated input data—in this case, an image. FIG. 4 depicts an example obfuscation 402 to be applied to the un-obfuscated input data 400. The example obfuscation is depicted in a black and white scale which represents the scale (e.g., not the sampled value of the obfuscation value distribution) of the obfuscation value distribution (e.g., maximum magnitude, average magnitude, etc.) applied to the input data. For each feature (e.g., pixel) of the input data, the obfuscation value may be randomly selected from one or more obfuscation value distribution 403. In some embodiments, the obfuscation value distribution 403 may be a Gaussian distribution (depicted in one dimension, but may have multiple dimensions, such as for each color value of a pixel, subpixel, etc.). In some embodiments, a Gaussian distribution may approximate the set of possible obfuscation values (e.g., manifold) which may satisfy the optimization function (e.g., maximize applied obfuscation while minimizing model inaccuracy). In some embodiments, by applying a diffusion-based distribution, a greater portion of the manifold of possible obfuscation values may be learned. For example, the two-dimensional manifold 409 may be learned for an example input data feature, whereas a Gaussian distribution 407 learned for the same input data feature may be smaller than the two-dimensional manifold 409 learned by applying (e.g., learning and fitting) a diffusion process. Although the space 406 of possible obfuscation values is depicted as two-dimensional, it may have more or fewer dimensions. Example obfuscated input data 404 may then be generated based on sampling from obfuscation value distributions and applying the sampled obfuscation values to the input data.

As data storage and analysis costs decrease (such as due to storage unit cost decrease, processing cost decrease, increased use of cloud computing, transmission speed increases, etc.), data collection by various entities (e.g., service providers, public safety entities, commercial enterprises, etc.) has increased, leading to generation of large troves of information, which may be referred to as “big data”. The data may exist in many forms: visual (e.g., image data), textual (e.g., language), tabular (e.g., columnar, spreadsheet, etc.), including in multiple forms within a single data collection. Rapid scaling of AI, including deep neural networks, has enabled entities to extract high value from data stores, such as by predictive customer churn, through generative modeling, etc. However, much of the data collected may contain highly sensitive information, such as facial images, public health information (PHI), etc. An entity may have obligations (legal, contractual, moral, etc.) to protect such sensitive information, including obligations to keep such data private or otherwise safe from access or dissemination. A transform that would protect the information in a model, including an untrusted model, while allowing value to be extracted from the data collection would allow an entity to operate a model, such as a foundation model, which is maintained by another entity for its own ends. More value may be extracted from more granular data, which may be less obfuscated—that is, there may be a tradeoff between value extraction and data privacy which may be adjusted.

A system and method for obfuscation of input data is described herein. In some embodiments, a Foundation Model (also referred to as a foundational model) is used. In some embodiments, a generative model is used. In some embodiments, any appropriate model, including a pre-trained model, is used. In some embodiments, self-supervised learning is used, such as for an autoencoder. A formulation is developed which may provide a method for obfuscating input data (including sensitive data), which may be include method for generating obfuscating layer(s). In some embodiments, given a foundation model that generates representations of the source data (e.g., the input data, the data of the data collection, or another data store), a transformation, may be learned (e.g., trained) which is a significant transform (e.g., obfuscating) in the input space (e.g., on the input data of the foundation model) but which is less significant or null in the output space (e.g., in the output space of the foundation model). In some embodiments, separate obfuscation operations may be performed on input data and output data. These transforms may therefore generate data (or other outputs) which are valuable for data inference, modeling, training, etc. purposes while maintaining data privacy, including in homomorphic encryption. This framework may be applied to a variety of data types, including but not limited to vision, text, and tabular datasets.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to cost constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A method comprising:
obtaining, by a computer system, input data for a machine learning model;
generating, by the computer system, one or more obfuscation value distribution for input data obfuscation based on a diffusion process;
training, by the computer system, the one or more obfuscation value distribution for data obfuscation; and
storing, by the computer system, the trained one or more obfuscation value distribution in memory.
